(19) United States
(12) Patent Application Publication
(10) Pub. No.: US 2005/0031212 A1
(43) Pub. Date: Feb. 10, 2005

(54) Image processing apparatus, image display system, program, and storage medium

(76) Inventor: Tooru Suino, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/891,591

(22) Filed: Jul. 14, 2004

(30) Foreign Application Priority Data
Jul. 14, 2003 (JP) 2003-196216

(51) Int. Cl. G06K 9/36

(52) U.S. Cl. 382/232

(57) ABSTRACT

A technique is disclosed for evaluating an audio characteristic such as singing ability, and processing an image to be displayed according to the evaluation result in a manner that can attract the interest of a user. JPEG 2000 code data of a moving image for a karaoke system, for example, are transmitted from a server to a client along with accompanying audio data, and the code data are then decoded at a decoder to form an image to be displayed. An audio signal such as the voice of the user that is input to a microphone is evaluated at an evaluation unit, and the evaluation result is transmitted to the server. Based on this evaluation result, an inter-code transform unit conducts image processing by selectively discarding codes from code data of an image that are to be transmitted to the client.

The present application claims priority to the corresponding Japanese Application No. 2003-196216, filed on Jul. 14, 2003, the entire contents of which are hereby incorporated by reference.

### BACKGROUND OF THE INVENTION

1. Field of the Invention

The present invention relates to an image processing apparatus that processes image data according to a result of evaluating an audio signal. The present invention also relates to a program that is run on a computer to execute such a process and a storage medium storing such a program.

2. Description of the Related Art

Prior art techniques for scoring the singing ability of a user singing a song in a karaoke system, and reflecting the resulting score on an image being displayed are disclosed in Japanese Laid-Open Patent Application No. 9-81165 and Japanese Laid-Open Patent Application No. 9-160574, for example.

In Japanese Laid-Open Patent Application No. 9-81165, a technique is disclosed in which a song playtime is subdivided into blocks, and a story represented by images being displayed is modified according to the singing ability of the user.

In Japanese Laid-Open Patent Application No. 9-160574, a technique is disclosed in which the respective singing abilities of two singers singing the same song simultaneously are scored, and the image area for the singer with the higher score is increased on the monitor screen.

However, in Japanese Laid-Open Patent Application No. 9-81165, the different stories to be represented according to the singing ability evaluation result are prepared beforehand, and thereby, the user is likely to get weary and lose interest after repeated usage of the system.

Also, since Japanese Laid-Open Patent Application No. 9-160574 is concerned with scoring the respective singing abilities of two singers singing the same song simultaneously and increasing the image area on the monitor screen of the singer with the higher score, this system cannot be used by one single user.

Further, Japanese Laid-Open Patent Application No. 9-160574 only discloses a technique for changing the image size based on the difference in scores between the two singers.

### SUMMARY OF THE INVENTION

An image processing apparatus, image display, system, program, and storage medium are described. In one embodiment, the image processing apparatus comprises a processing unit to process image data encoded through wavelet transform according to a result of evaluating a single audio signal.

### BRIEF DESCRIPTION OF THE DRAWINGS

FIG. 1 is a flowchart illustrating the process flow of quantization, code discarding, and image quality control processes;

FIG. 2 is a diagram showing the relation between an image, a tile, a sub-band, a precinct, and a code-block;

FIG. 3 is a table showing exemplary layers in a case where the wavelet transform decomposition level is 2, and the precinct size is equal to the sub-band size;

FIG. 4 is a table showing exemplary packets included in the layers of FIG. 3;

FIG. 5 is a block diagram illustrating an exemplary configuration of an image display system according to an embodiment of the present invention;

FIG. 6 is a block diagram illustrating another exemplary configuration of an image display system according to an embodiment of the present invention;

FIG. 7 is a block diagram illustrating yet another exemplary configuration of one embodiment of the present invention;

FIG. 8 is a block diagram illustrating the electrical connections of a client or a server;

FIG. 9 is a timing chart showing the processes being performed by the image display system;

FIGS. 10A and 10B illustrate an exemplary image processing technique in which the size of an image is changed;

FIGS. 11A and 11B illustrate an exemplary image processing technique in which the image quality is degraded;

FIGS. 12A and 12B illustrate an exemplary image processing technique in which the color of an image is reduced; and

FIGS. 13A and 13B illustrate an exemplary image processing technique in which portions of an image are discarded.

### DESCRIPTION OF THE PREFERRED EMBODIMENTS

In one embodiment of the present invention, a user's singing ability is evaluated, and an image to be displayed is processed according to the evaluation in a manner that can attract the interest of the user. In another embodiment, a user is enabled to use such technology alone.

One embodiment of the present invention comprises an image processing apparatus that processes image data according to a result of evaluating a single audio signal. Based on a result of evaluating an audio signal characteristic such as the singing ability of a user inputting his/her singing voice, image data may be processed in various ways that can attract the interest of the user.

According to one embodiment of the present invention, the processing of the image data may involve changing the image size of the image data according to the evaluation result. By processing the image data through changing the image size of the image data according to an evaluation result pertaining to the singing ability of a user, for example, the interest of the user may be maintained.

According to another embodiment of the present invention, the image processing may involve degrading the image quality of the image data according to the evaluation result. By processing the image data in order to degrade the image quality according to an evaluation result pertaining to the singing ability of a user, for example, the interest of the user may be maintained.

According to another embodiment of the present invention, the image processing may involve reducing image color of the image data according to the evaluation result. By processing the image data in order to reduce the color of the image based on an evaluation result pertaining to the singing ability of a user, for example, the interest of the user may be maintained.

According to another embodiment of the present invention, the image processing may involve discarding a portion of the image data according to the evaluation result. By processing the image data through discarding a portion of the image data according to an evaluation result pertaining to the singing ability of a user, for example, the interest of the user may be maintained.

In another embodiment, an image processing apparatus processes image data by degrading image quality of the image data according to a result of evaluating an audio signal. By degrading the image quality of image data according to the evaluation, the interest of the user may be maintained.

In another embodiment, an image processing apparatus processes image data by reducing image color of the image data according to a result of evaluating an audio signal. By reducing the color of the image according to the evaluation, the interest of the user may be maintained.

In another embodiment, an image processing apparatus processes image data by discarding a portion of the image data according to a result of evaluating an audio signal. By discarding a portion of the image data according to the evaluation, the interest of the user may be maintained.

According to another embodiment of the present invention, the evaluation result is obtained by comparing the waveform of an audio signal with the waveform of comparison data provided beforehand. By comparing the waveform of the audio signal with the waveform of the comparison data, for example, the singing ability of a user may be evaluated and image processing may be conducted accordingly.

According to another embodiment of the present invention, the evaluation result is obtained by comparing a volume (amplitude) of the audio signal with a volume of comparison data provided beforehand. In this way, image processing may be conducted based on an evaluation of the volume of an audio signal.

According to another embodiment of the present invention, the image data corresponds to code data encoded by the JPEG 2000 algorithm, and the image processing involves discarding a portion of codes of this code data. In this way, image processing is performed on image data in an encoded state.

According to another preferred embodiment, the image processing apparatus successively executes a procedure to process predetermined image data during a predetermined time period according to the evaluation result obtained during this predetermined time period, which predetermined image data are used to form an image to be displayed during a next predetermined time period. In this way, for example, in a karaoke system, input audio is progressively evaluated, and an image to be displayed is progressively processed accordingly.

In another embodiment, an image display system includes an image processing apparatus, an evaluation unit that evaluates the audio signal, and a display apparatus that displays an image based on the processed image data Based on a result of evaluating an audio signal characteristic such as the singing ability of a user inputting his/her singing voice, image data may be processed in various ways that can attract the interest of the user.

In another embodiment, an image display apparatus includes an image processing apparatus that processes image data through successively executing the image processing procedure at predetermined time periods, an evaluation unit that evaluates the audio signal, and a display apparatus that displays an image corresponding to the processed image data in sync with the successive execution of the image processing procedure. In this way, for example, the voice of the user being input may be evaluated, and the evaluation of the singing ability of the user may be immediately reflected in the image being displayed in sync with the song being replayed, by processing image data in various ways that may attract the interest of the user.

In another embodiment, a computer readable program that is run on a computer includes a procedure for processing image data according to a result of evaluating a single audio signal. In this way, based on a result of evaluating the voice of a user being input, for example, image data may be processed in various ways that may tract the interest of the user. Since the evaluation is made with respect to a single audio signal, one embodiment of the present invention may be used by a single user.

In another embodiment, a computer readable program that is run on a computer includes a procedure for processing image data by degrading the image quality of the image data according to a result of evaluating an audio signal. By processing the image in order to degrade the image quality, the interest of the user may be maintained.

In another embodiment, a computer readable program that is run on a computer includes a procedure for processing image data by reducing image color of the image data according to a result of evaluating an audio signal. By processing the image data in order to reduce the image color, the interest of the user may be maintained.

In another embodiment, a computer readable program that is run on a computer includes a procedure for processing image data by discarding a portion of the image data according to a result of evaluating an audio signal. By processing the image data through discarding a portion of the image data, the interest of the user may be maintained.

The present invention according to another embodiment provides a storage medium that stores a program of the present invention.

JPEG 2000

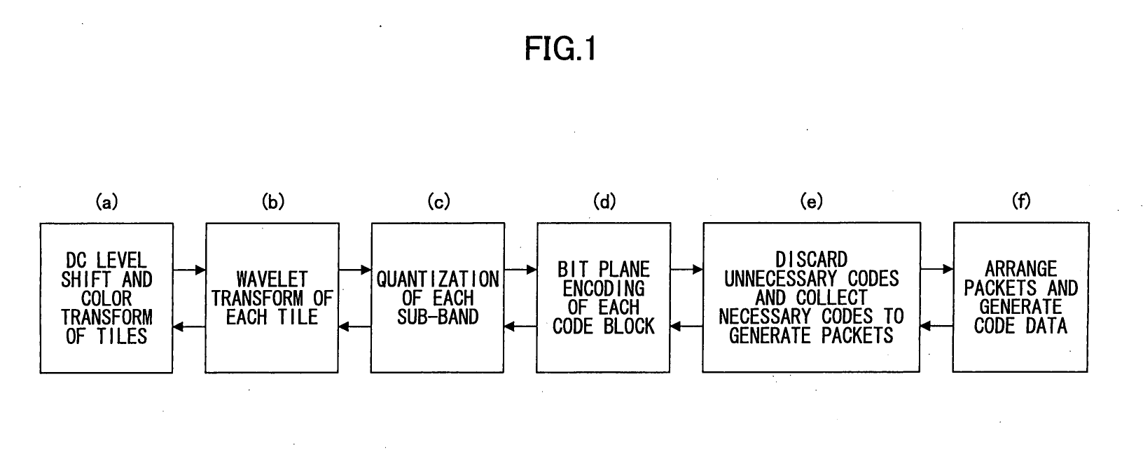

First, quantization, code discarding and image quality control processes according to JPEG 2000 are described. FIG. 1 illustrates an overall flow of an encoding process according to JPEG 2000. Upon encoding image data according to JPEG 2000, an image is divided into tiles; DC level shifting and color transform processes are conducted on the tiles (a); wavelet transform is conducted on each tile (b); and quantization is conducted on each sub-band (c). Then, bit-plane encoding is conducted on each code block (d); and unnecessary codes are discarded and necessary codes are collected to generate packets (e). Then, the packets are arranged to form code data (f). Upon decoding the code data, the above processes are performed in reverse order.

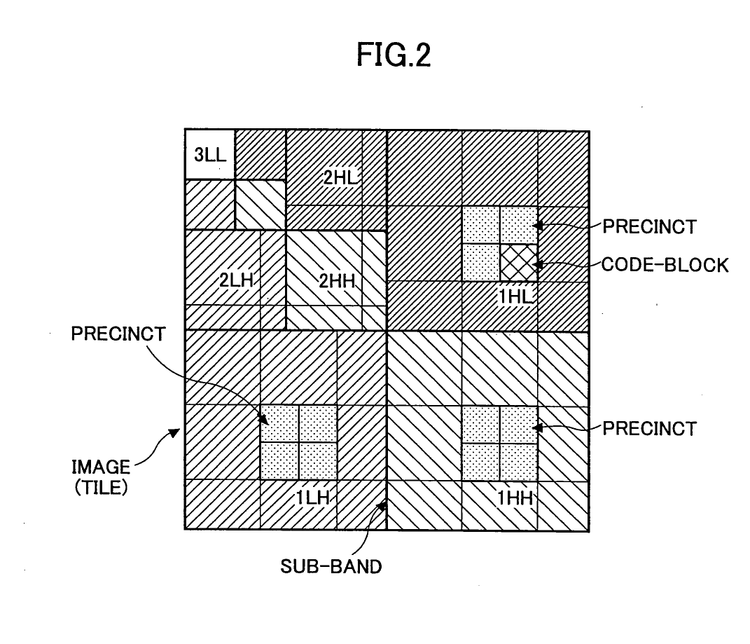

FIG. 2 is a diagram showing the relation between an image, a tile, a sub-band, and a code block. A tile corresponds to a rectangular division unit of an image, and when the image division level equals 1, then tile equals the image. In JPEG 2000, individual tiles are each regarded as independent images, and wavelet transform is conducted on each of these tiles to generate sub-bands. According to a standard JPEG 2000 scheme, when a 9×7 transform is used as the wavelet transform, the coefficients included in a certain sub-band are divided by the same number to be linearly quantized. In this way, image quality control through linear quantization may be conducted for each sub-band (i.e., the sub-band may be used as the unit for image quality control through linear quantization).

A precinct corresponds to a rectangular division unit (having a size that may be determined by the user) of a sub-band. More specifically, a precinct may correspond to a collection of three corresponding rectangular division units of the three sub-bands HL, LH, and HH, or one rectangular division unit of the LL sub-band. A precinct roughly represents a position within an image. It is noted that a precinct may have the same size as the sub-band, and a precinct may be further divided into a rectangular division unit (of a size that may be determined by the user) to generate a code block.

The code block is used as a unit for conducting bit-plane encoding on the coefficients of a quantized sub-band (one bit plane is decomposed into three sub-bit planes and encoded). Packets correspond to a portion of codes that are extracted from all the code blocks included in a precinct (e.g., a collection of codes corresponding to the three most significant bit planes of all the code blocks). It is noted that the term “portion” of codes may also refer to an “empty” state in which the packet contains no codes.

When the packets of all the precincts (i.e., all the code blocks, and all the sub-bands) are collected, a portion of the codes of the overall image (e.g., codes corresponding to the three most significant bit planes of the wavelet coefficients of the overall image) may be obtained, and this is referred to as a layer. Since a layer roughly represents a portion of the codes of bit planes of the overall image, the image quality may be improved as the number of layers to be decoded increases. In other words, a layer may be regarded as a unit for determining the image quality.

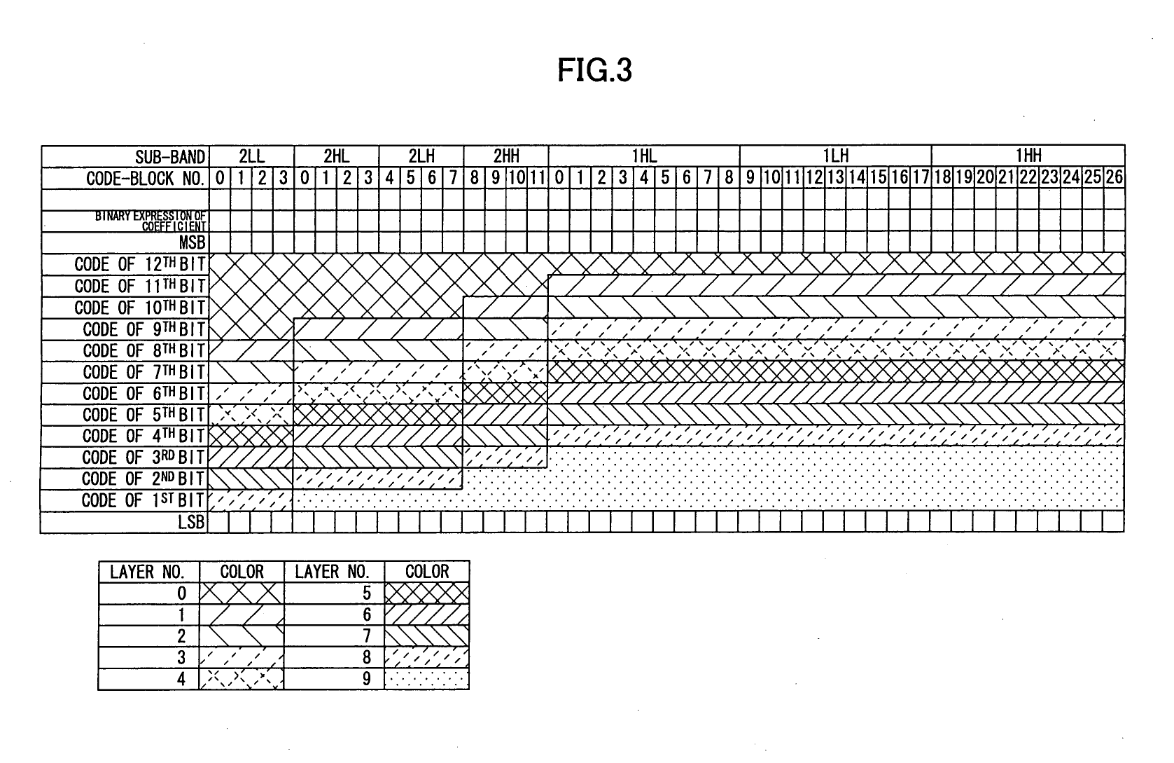

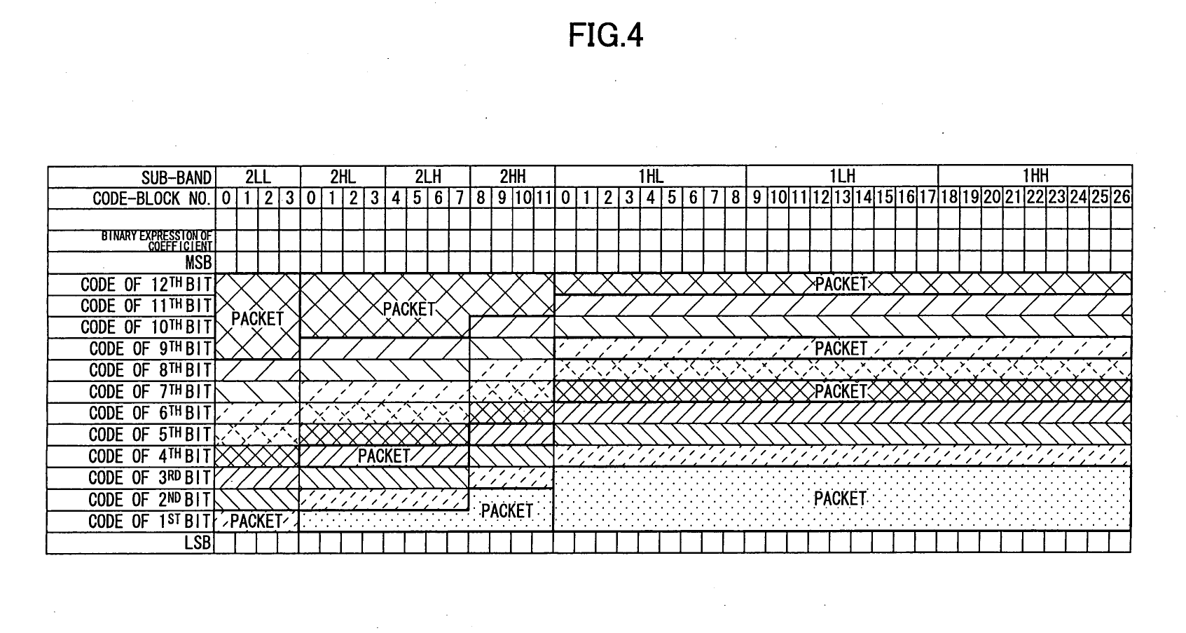

When all the layers are collected, codes of all the bit planes of the overall image may be obtained. FIG. 3 is a table showing exemplary layers in a case where the decomposition level of the wavelet transform equals 2 and precinct size equals the sub-band size. FIG. 4 is a table showing exemplary packets that may be included in such layers. According to this example, since the precinct size equals the sub-band size, a code block having a size corresponding to the size of the precinct shown in FIG. 2 is used, and thereby, the sub-bands of decomposition level 2, are divided into four code blocks, and the sub-bands of decomposition level 1 are divided into nine code blocks. Since packets use precincts as their unit, if precinct equals a sub-band, then the packets may cross over the HL˜HH sub-bands. In FIG. 4, a number of packets are indicated by bold lines.

It is noted that packets correspond to a portion of codes from one or more code blocks that are extracted and collected, and the rest of the unnecessary codes do not have to be generated as packets. For example, in FIG. 3, codes of an insignificant bit plane such as that included in layer No. 9 are usually discarded.

In this way, image quality control through code discarding may be conducted for each code block (and for each sub-bit plane). That is, the code block is used as the unit for conducting image quality control though code discarding. It is noted that the arrangement of packets is referred to as progression order.

### Embodiments

In the following, embodiments of the present invention are described.

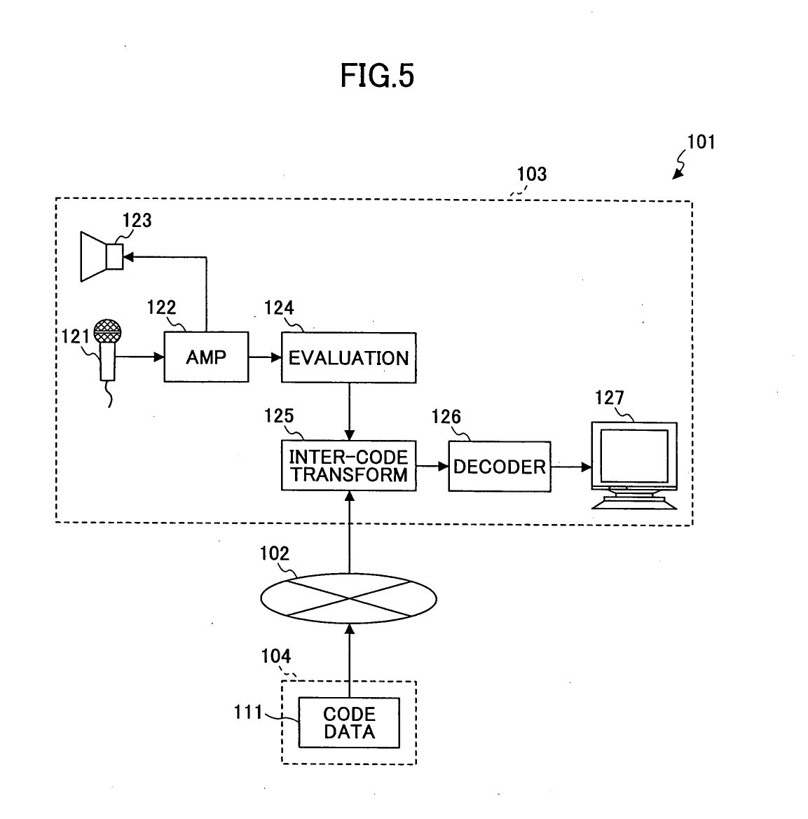

FIG. 5 is a block diagram showing an exemplary configuration of an image display system 101 according to an embodiment of the present invention. The image display system 101 includes a client 103 corresponding to an image processing apparatus that receives code data of a moving image or a still image via a network 102, and a server 104 that supplies the code data.

The server 104 transmits moving image or still image code data 111 accumulated therein to the client 103. The moving image or still image code data 111 used in this example are encoded according to a compression scheme, such as JPEG 2000 and motion JPEG 2000, that allows editing of code data in their encoded state without having to be decoded.

The client 103 includes a microphone 121 for inputting an audio signal, an amplifier 122 for amplifying this audio signal, and a speaker 123 for outputting the amplified audio signal.

Also, the client 103 includes an evaluation unit 124 for evaluating the audio signal such as a user's voice or the sound of an instrument that is input to the microphone 121 based on a predetermined criterion. For example, the evaluation unit 124 may compare the waveform of the input audio signal with the waveform of comparison data that are stored beforehand, and evaluate the input audio signal based on the absolute value difference between the waveforms. In another example, to augment the amusement factor, the audio volume may be used in evaluating the singing ability (e.g., evaluation using comparison data pertaining to audio volume). The evaluation result obtained from the evaluation unit 124 is input to an inter-code transform unit 125. The inter-code transform unit 125 conducts image processing through discarding a portion of codes according to the evaluation result pertaining to the singing ability of the user, for example. After discarding the unnecessary codes, the remaining code data are decoded at a decoder 126, and used by display unit 127 to produce a moving image, for example.

In a case where the image display system 101 is used as a communications karaoke system, the moving image code data in the server 104 may be accompanied by audio data corresponding to the accompaniment of a song (and this audio data may also be compressed, encoded, and transmitted). In this case, the audio data (in a decoded state if initially encoded) are mixed with the voice input to the microphone 121 by the user, and output from the speaker 123 in sync with the moving image displayed at the display unit 127.

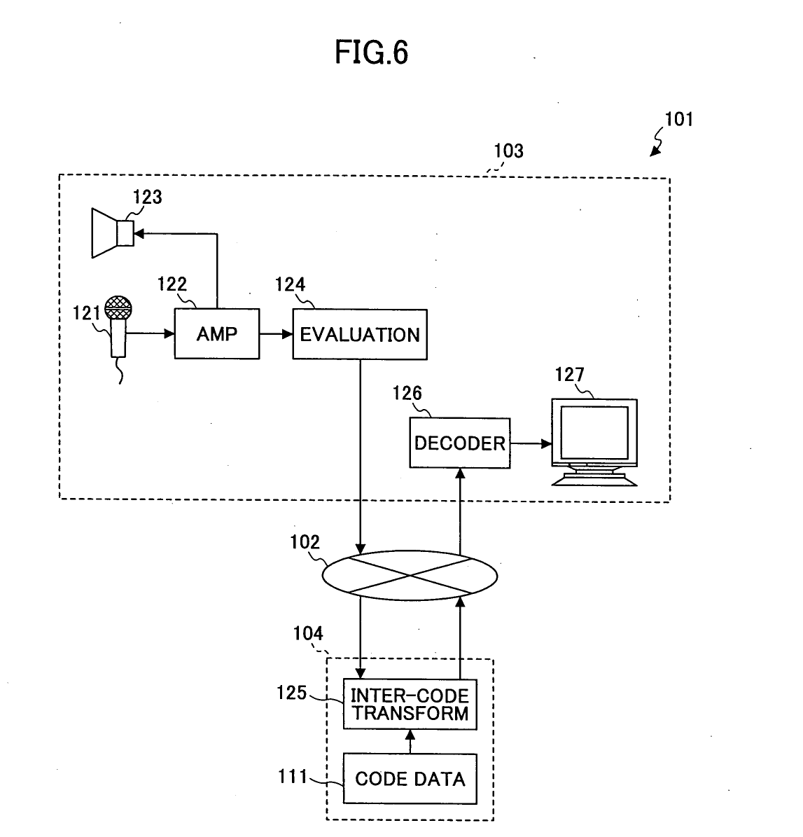

FIG. 6 is a block diagram illustrating another exemplary configuration of the image display system 101. The difference between the image display system of FIG. 5 and the image display system of FIG. 6 lies in the fact that the inter-code transform unit 125 is implemented in the server 104 in the example of FIG. 6. Thereby, unnecessary codes are discarded at the server 104 after which the resulting code data are transmitted to the client 103. According to this example, the server 104 corresponds to the image processing apparatus.

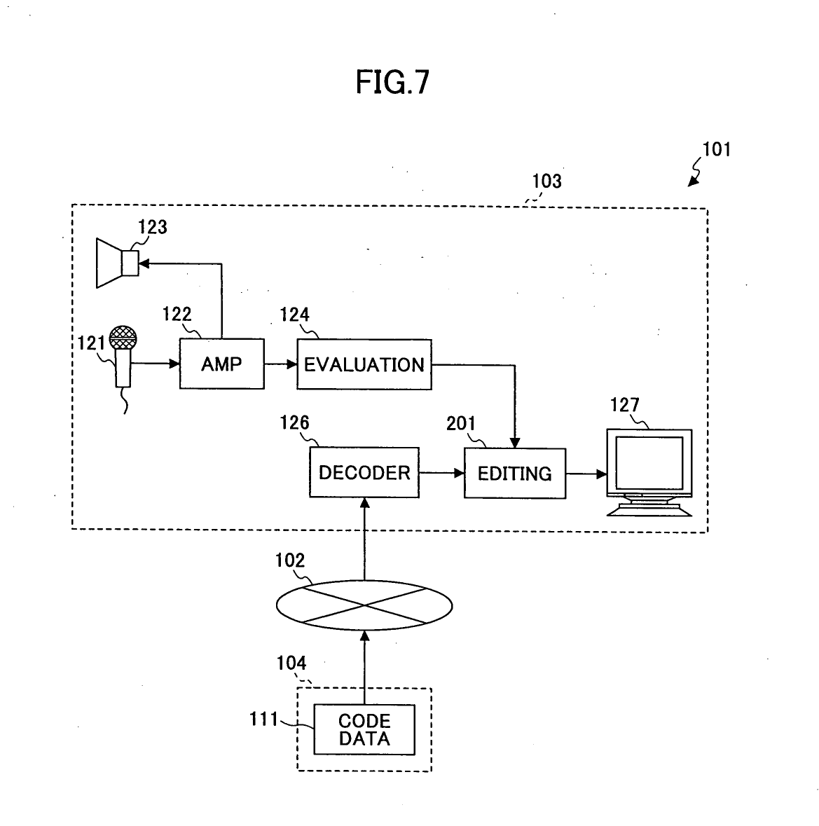

FIG. 7 is a block diagram showing yet another exemplary configuration of the image display system 101. The difference between the image display system of FIG. 5 and that of FIG. 7 lies in the fact that in the example of FIG. 7, the code data transmitted by the server 104 correspond to a still image that is encoded by a JPEG compression algorithm, and in the client 103 corresponding to the image processing apparatus, an editing unit 201 is implemented instead of the inter-code transform unit 125, which editing unit 201 processes the image data decoded by the decoder 126. In other words, unlike code data encoded according to the JPEG 2000 standard, codes cannot be partially discarded from code data in their encoded state when the code data are encoded according to the JPEG standard, and thereby the code data are arranged to be decoded before being processed.

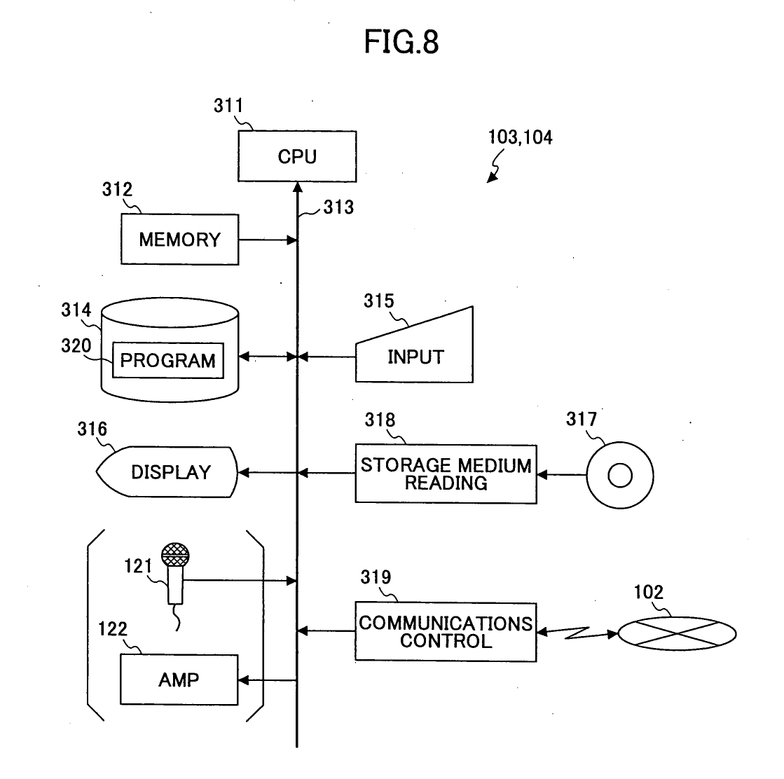

FIG. 8 is a block diagram illustrating an example of electrical connections of the client 103 or the server 104. As is shown in FIG. 8, the client 103 and the server 104 each include a CPU 311 for performing various computations and centrally controlling each component part of the apparatus, a memory 312 that includes various ROMs and RAMs, and a bus 313.

The bus 313 is connected, via predetermined interfaces, to a magnetic storage device 314 such as a hard disk, an input device 315 such as a keyboard and/or a mouse, a display apparatus 316, and a storage medium reading device 318 that reads a storage medium 317 such as an optical disk. Also, the bus 313 is connected to a predetermined communication interface 319 that establishes communication with the network 102. It is noted that various types of media may be used as the storage medium 317, which may correspond to an optical disk such as a CD or a DVD, a magneto-optical disk, or a flexible disk, for example. The storage medium reading device 318 may correspond to an optical disk device, a magneto-optical disk device, or a flexible disk device, for example, according to the type of storage medium 317 being used.

The client 103 and the server 104 are adapted to read one or more programs 320 from the storage medium 317 and install the programs 320 in the magnetic storage device 314. Programs may also be downloaded via the network 102 such as the Internet and installed. By installing these programs, the client 103 and the server 104 may be able to execute the various procedures including the image processing procedure described above. It is noted that the programs 320 may correspond to programs that are operated on a predetermined OS.

It is noted that in the client 103, the bus 313 is also connected to the microphone 121 and the amplifier 122 via predetermined interfaces.

By executing the processes according to the installed programs 320, the functions of the respective component parts such as the evaluation unit 124, the decoder 126, the inter-code transform unit 125, the editing unit 201, and the display unit 127 may be realized and an image may be displayed on the display apparatus 316 by the display unit 127.

As can be appreciated from the above descriptions, the image display system may be arranged to have various system configurations. In the example of FIG. 6, the client 103 merely decodes the code data to display a corresponding image, and thereby, the processing time may be reduced. Also, in this example, since the JPEG 2000 standard is used, the code data transmitted from the server 104 corresponds to partially discarded code data, and thereby, network traffic may be reduced as well. In the following, embodiments of the present invention are described mainly in connection with the image display system 101 of FIG. 6.

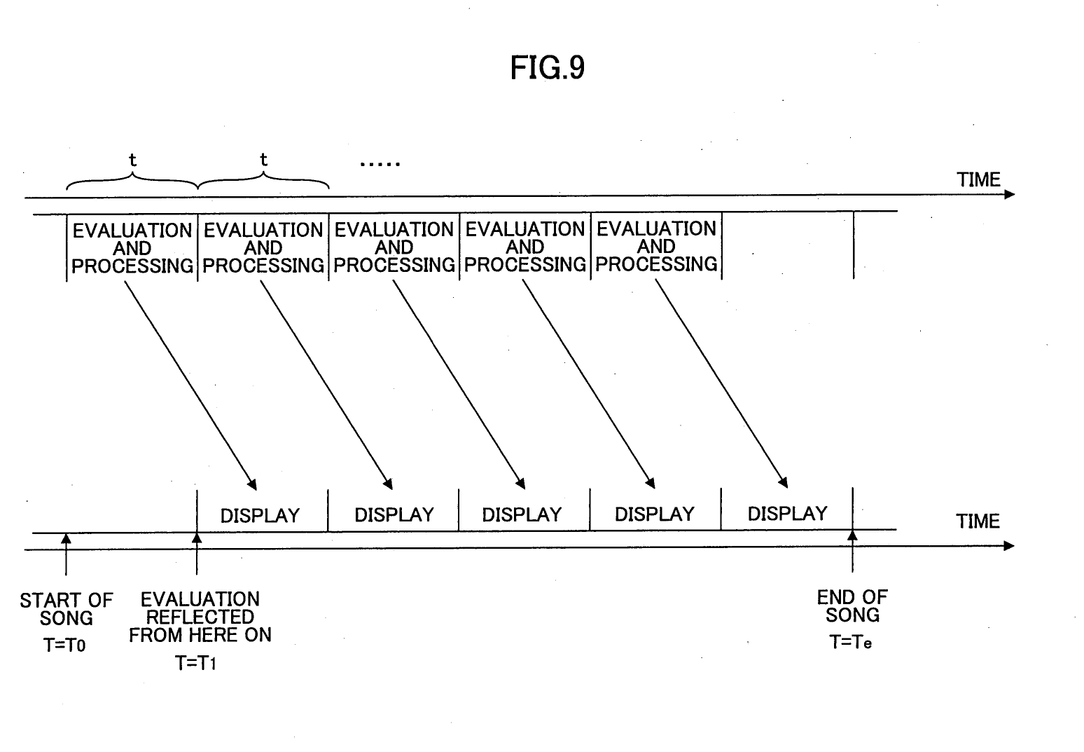

FIG. 9 is a process time table illustrating the processes executed in the image display system 101. In this example, the image display system 101 is described as a communications karaoke system. Specifically, audio data downloaded from the server 104 are replayed starting from time T=T₀, and until time T=T₁, moving image data decoded at the decoder 126 are replayed in sync with the audio data being replayed. After time T=T₁, evaluation by the evaluation unit 124 of the singing voice input to the microphone 121 and image processing through partial discarding of codes by the inter-code transform unit 125 or image processing by the editing unit 201 based on the evaluation result are conducted in time division units of t.

Accordingly, a moving image obtained from evaluation and image processing during time period t is displayed during the next time period t. In a case of displaying one still image, when obtaining an image from evaluation and image processing during time period t for display during the next time period t, the image being subjected to the image processing corresponds to the same image for each time period t, but the images being displayed at the respective time periods t may differ depending on their corresponding evaluations affecting the image processing. In other words, in this example, a procedure of making an evaluation and processing image data at time period t and displaying the resulting image during the next time period t is repeatedly performed with respect to the same image in cycles of time period t. Alternatively, in a case of successively displaying plural still images like a slide show, a procedure of making an evaluation and processing a still image during time period t, and displaying the processed image during the next time period t is performed for each still image in cycles of time period t. In any case, a procedure of evaluating a singing ability and processing image data during a certain time period t for displaying the processed image during the next time period t is successively performed. The image corresponding to the processed image data is displayed on the display apparatus 316 in sync with the successive execution of the above procedure.

In the following, exemplary techniques for processing image data are described.

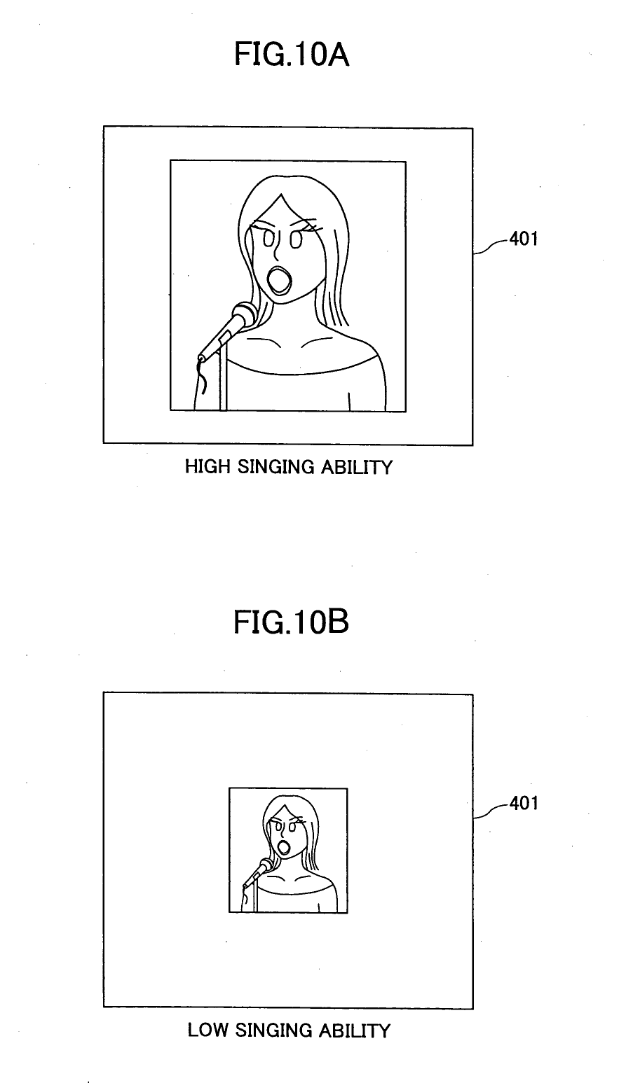

FIGS. 10A and 10B illustrate an example of a resolution progressive image display. According to this example, in the system configurations of FIG. 5 and FIG. 6, if the singing ability of the user is evaluated as high, codes of high frequency levels are not discarded from the JPEG 2000 code data at the inter-code transform unit 125 so that the image being displayed may take up a large portion of a display area 401 (FIG. 10A). On the other hand, when the singing ability of the user is low, codes of high frequency band levels are discarded, and thereby, the image being displayed may be reduced in size (FIG. 10B). It is noted that in this example, the code data are encoded according to a resolution progressive scheme beforehand.

Also, it is noted that in the example of FIG. 7, a known technique may be used to change the size of an image being displayed according to the singing ability of the user.

In this case, a background image may be changed according to the singing ability of the user, or an image of the user may be captured (e.g., a still image or a moving image) and this image may be displayed as a portion of the background image, wherein the size of the image of the user changes according to the singing ability of the user. In the latter example, the code data corresponding to the captured image of the user are encoded using a resolution progressive scheme.

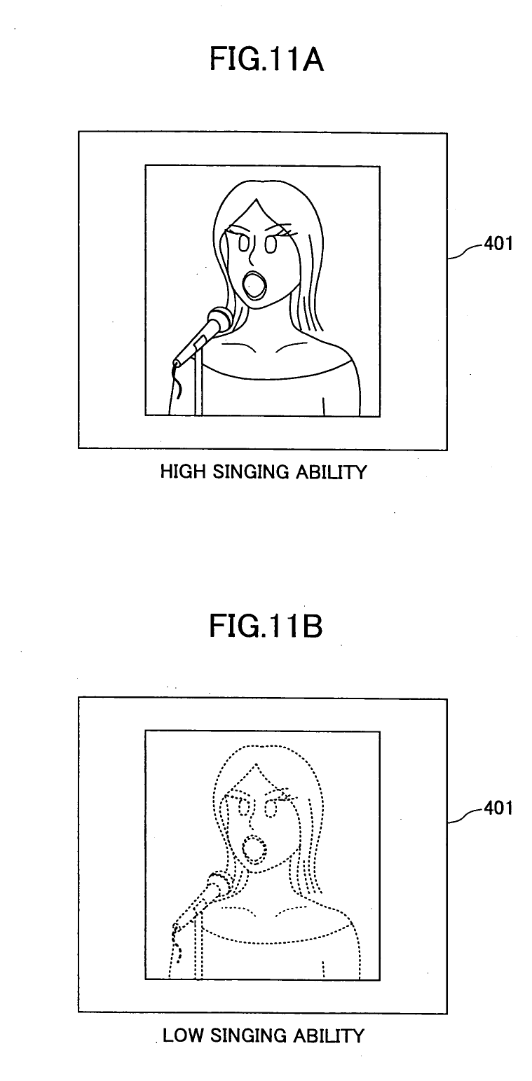

FIGS. 11A and 11B illustrate an example of an image quality progressive image display. According to this example, in the image display systems of FIG. 5 and FIG. 6, when the singing ability of the user is evaluated as high, even codes of insignificant layers in the JPEG 2000 code data are not discarded so that a high definition image may be displayed (FIG. 11A). On the other hand, when the singing ability of the user is low, the codes of the insignificant layers are discarded and a degraded and low definition image is displayed (FIG. 11B). It is noted that, in this example, the code data are encoded according to an image quality progressive scheme beforehand.

Also, it is noted that in the image display system of FIG. 7, a known technique may be used to change the definition of an image being displayed according to the singing ability of the user.

In this case, a background image may be changed according to the singing ability of the user, or an image of the user may be captured (e.g., a still image or a moving image) and this image may be displayed as a portion of the background image, wherein the definition of the image of the user changes according to the singing ability of the user. In the latter example, the code data corresponding to the captured image of the user are encoded using an image quality progressive scheme.

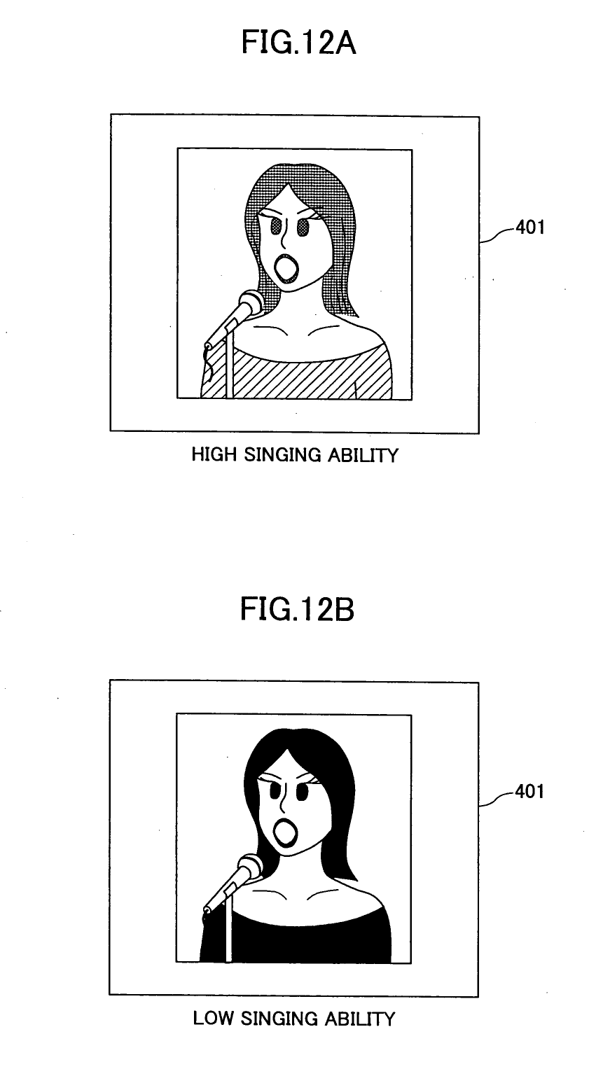

FIGS. 12A and 12B illustrate an example of a component progressive image display. According to this example, in the image display systems of FIG. 5 and FIG. 6, when the singing ability of the user is evaluated as high, the brightness and the color difference codes of the JPEG 2000 code data are not discarded at the inter-code transform unit 125 so that a high definition color image may be displayed (FIG. 12A). On the other hand, when the singing ability of the user is low, the color difference codes are discarded according to the singing ability of the user so that an image with less color (like a monochrome image) is displayed (FIG. 12B). It is noted that the code data are encoded according to a component progressive scheme.

Also, it is noted that in the image display system of FIG. 7, a known technique may be used to reduce the color of an image according to the singing ability of the user.

In this case a background image may be changed according to the singing ability of the user, or an image of the user may be captured (e.g., a still image or a moving image) and this image may be displayed as a portion of the background image, wherein the color of the image of the user is reduced according to the singing ability of the user. In the latter example, the code data corresponding to the captured image of the user are encoded using a component progressive scheme.

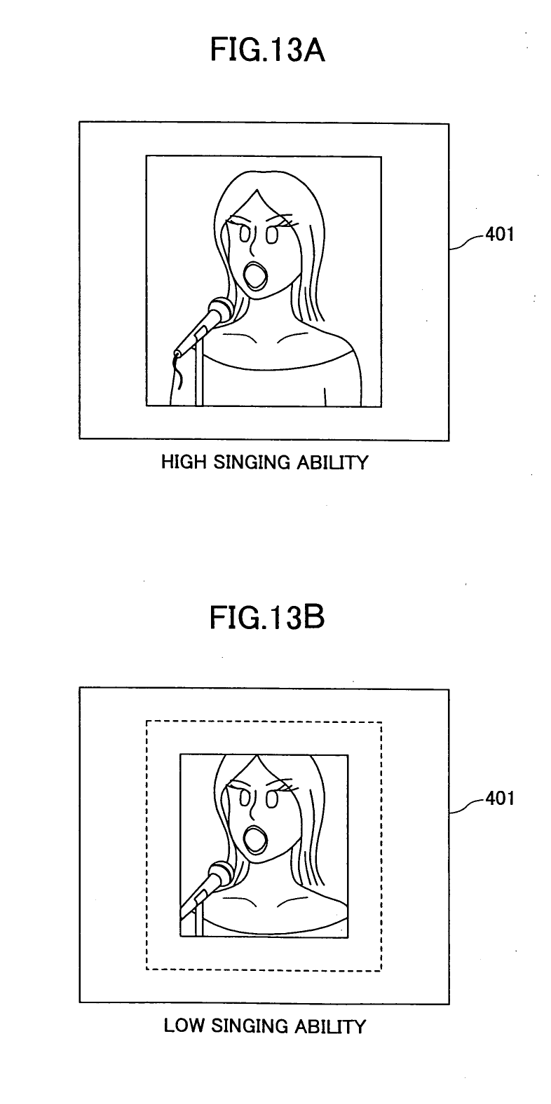

FIGS. 13A and 13B illustrate an example of a position progressive image display. According to this example, in the image display systems of FIG. 5 and FIG. 6, when the singing ability of the user is evaluated as high, the codes of all tiles are left without being discarded so that a full-color full-size image may be displayed (FIG. 13A). On the other hand, when the singing ability of the user is low, codes of the tiles are randomly discarded so that some portions of the image may be missing, or alternatively, codes of tiles corresponding to the outer periphery of the image may be discarded so that outer periphery portions may be missing from the image being displayed (FIG. 13B). It is noted that in this example, the code data are encoded according to a position progressive scheme beforehand.

Also, it is noted that in the image display system of FIG. 7, a known technique may be used to discard image data corresponding to portions of an image according to the singing ability of the user.

In this case, a background image may be changed according to the singing ability of the user, or an image of the user may be captured (e.g., a still image or a moving image) and this image may be displayed as a portion of the background image, wherein a portion of the code data of the image of the user may be discarded in response to a poor singing ability. In the latter example, the code data corresponding to the captured image of the user are encoded using a position progressive scheme.

In the examples of FIGS. 10˜13, the image processing is illustrated by alternating between two levels; however, a singing ability may be evaluated and categorized into three or more levels and the image processing may alternate between the three or more levels.

Also, the above examples are illustrated using a voice of a user as an example of an audio signal being input; however, the present invention is not limited to such embodiment. For example, the input audio signal may correspond to a sound of an instrument. In such case, the ability to play the instrument is evaluated, the practice efforts (degree of progress) may be reflected in the image being displayed instead of a numerical value, for example, and the user may be more interested in the output, thereby finding motivation to practice further.

The present application is based on and claims the benefit of the earlier filing date of Japanese Patent Application No. 2003-196216 filed on Jul. 14, 2003, the entire contents of which are hereby incorporated by reference.

1. An image processing apparatus comprising:
a processing unit to process image data encoded through wavelet transform according to a result of evaluating a single audio signal.

2. The image processing apparatus as claimed in claim 1, wherein the processing unit changes an image size of the image data according to the evaluation result.

3. The image processing apparatus as claimed in claim 1, wherein the processing unit degrades an image quality of the image data according to the evaluation result.

4. The image processing apparatus as claimed in claim 1, wherein the processing unit reduces an image color of the image data according to the evaluation result.

5. The image processing apparatus as claimed in claim 1, wherein the processing unit discards a portion of the image data according to the evaluation result.

6. The image processing apparatus as claimed in claim 1, wherein the evaluation result is obtained by comparing a waveform of the audio signal with a waveform of comparison data provided beforehand.

7. The image processing apparatus as claimed in claim 1, wherein the evaluation result is obtained by comparing a volume of the audio signal with a volume of comparison data provided beforehand.

8. The image processing apparatus as claimed in claim 1, wherein the image data correspond to code data encoded by a JPEG 2000 algorithm, and the processing unit discards a portion of codes of the code data.

9. The image processing apparatus as claimed in claim 1, wherein the processing unit successively executes a procedure of processing predetermined image data during a predetermined time period according to the evaluation result obtained during the predetermined time period, an image of which predetermined image data is to be displayed during a next predetermined time period.

10. An image processing apparatus comprising:
a processing unit to process image data encoded through wavelet transform by degrading an image quality of the image data according to a result of evaluating an audio signal.

11. The image processing apparatus as claimed in claim 10, wherein the evaluation result is obtained by comparing a waveform of the audio signal with a waveform of comparison data provided beforehand.

12. The image processing apparatus as claimed in claim 10, wherein the evaluation result is obtained by comparing a volume of the audio signal with a volume of comparison data provided beforehand.

13. The image processing apparatus as claimed in claim 10, wherein the image data correspond to code data encoded by a JPEG 2000 algorithm, and the processing unit discards a portion of codes of the code data.

14. The image processing apparatus as claimed in claim 10, wherein the processing unit successively executes a procedure to process predetermined image data during a predetermined time period according to the evaluation result obtained during the predetermined time period, an image of which predetermined image data is to be displayed during a next predetermined time period.

15. An image processing apparatus comprising:
a processing unit to process image data encoded through wavelet transform by reducing an image color of the image data according to a result of evaluating an audio signal.

16. The image processing apparatus as claimed in claim 15, wherein the evaluation result is obtained by comparing a waveform of the audio signal with a waveform of comparison data provided beforehand.

17. The image processing apparatus as claimed in claim 15, wherein the evaluation result is obtained by comparing a volume of the audio signal with a volume of comparison data provided beforehand.

18. The image processing apparatus as claimed in claim 15, wherein the image data correspond to code data encoded by a JPEG 2000 algorithm, and the processing unit discards a portion of codes of the code data.

19. The image processing apparatus as claimed in claim 15, wherein the processing unit successively executes a procedure to process predetermined image data during a predetermined time period according to the evaluation result obtained during the predetermined time period, an image of which predetermined image data is to be displayed during a next predetermined time period.

20. An image processing apparatus comprising:
a processing unit to process image data encoded through wavelet transform by discarding a portion of the image data according to a result of evaluating an audio signal.

21. The image processing apparatus as claimed in claim 20, wherein the evaluation result is obtained by comparing a waveform of the audio signal with a waveform of comparison data provided beforehand.

22. The image processing apparatus as claimed in claim 20, wherein the evaluation result is obtained by comparing a volume of the audio signal with a volume of comparison data provided beforehand.

23. The image processing apparatus as claimed in claim 20, wherein the image data correspond to code data encoded by a JPEG 2000 algorithm, and the processing unit discards a portion of codes of the code data.

24. The image processing apparatus as claimed in claim 20, wherein the processing unit successively executes a procedure to process predetermined image data during a predetermined time period according to the evaluation result obtained during the predetermined time period, an image of which predetermined image data is to be displayed during a next predetermined time period.

25. An image display system comprising:
an image processing apparatus to perform at least one of processing image data encoded through wavelet transform according to a result of evaluating a single audio signal, processing image data encoded through wavelet transform by changing an image size of the image data according to a result of evaluating an audio signal, processing image data encoded through wavelet transform by degrading an image quality of the image data according to a result of evaluating an audio signal, processing image data encoded through wavelet transform by reducing an image color of the image data according to a result of evaluating an audio signal, and processing image data encoded through wavelet transform by discarding a portion of the image data according to a result of evaluating an audio signal;
an evaluation unit to evaluate the audio signal; and
a display apparatus to display an image based on the processed image data.

26. An image display system comprising:
an image processing apparatus to successively execute a procedure of processing predetermined image data encoded through wavelet transform during a predetermined time period according to a result of evaluating an audio signal during the predetermined time period, an image of which predetermined image data is to be displayed during a next predetermined time period;
an evaluation unit to evaluate the audio signal; and
a display apparatus to display the image corresponding to the processed image data in sync with the successive execution of the procedure.

27. An article of manufacture having one or more readable media storing a computer readable program having instructions, which, when executed by a computer, causes the computer to:
process image data encoded through wavelet transform according to a result of evaluating a single audio signal.

28. An article of manufacture having one or more readable media storing a computer readable program having instructions, which, when executed by a computer, causes the computer to:
process image data encoded through wavelet transform by degrading an image quality of the image data according to a result of evaluating an audio signal.

29. An article of manufacture having one or more readable media storing a computer readable program having instructions, which, when executed by a computer, causes the computer to:
process image data encoded through wavelet transform by reducing an image color of the image data according to a result of evaluating an audio signal.

30. An article of manufacture having one or more readable media storing a computer readable program having instructions, which, when executed by a computer, causes the computer to:
process image data encoded through wavelet transform by discarding a portion of the image data according to a result of evaluating an audio signal.

31. An article of manufacture having one or more readable media storing a computer readable program having instructions, which, when executed by a computer, causes the computer to:
execute a procedure to process image data encoded through wavelet transform according to a result of evaluating a single audio signal;
execute a procedure to process image data encoded through wavelet transform by degrading an image quality of the image data according to a result of evaluating an audio signal;
execute a procedure to process image data encoded through wavelet transform by reducing an image color of the image data according to a result of evaluating an audio signal; and
execute a procedure to process image data by discarding a portion of the image data encoded through wavelet transform according to a result of evaluating an audio signal.
